(19) United States
(12) Patent Application Publication
(10) Pub. No.: US 2006/0280083 A1
(43) Pub. Date: Dec. 14, 2006

(54) Method of determining type of optical medium, and optical medium driving system and recording medium therefor

(75) Inventor: Jung-won Lee, Ansan-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/395,297

(22) Filed: Apr. 3, 2006

(30) Foreign Application Priority Data
May 24, 2005 (KR) 10-2005-0043762

(51) Int. Cl. G11B 5/58

(52) U.S. Cl. 369/53.2

(57) ABSTRACT

A method of determining the type of an optical medium loaded into an optical medium driving system, the optical medium driving system, and a recording medium therefor. The method includes determining the type of the loaded optical medium by selecting the type of an optical medium to be determined based on predetermined sequence information; and updating the predetermined sequence information such that the type of the loaded optical medium outranks the other types of optical media listed in the predetermined sequence information, if the type of the loaded optical medium is determined.

### CROSS-REFERENCE TO RELATED PATENT APPLICATIONS

This application claims priority from Korean Patent Application No. 10-2005-0043762, filed on May 24, 2005, in the Korean Intellectual Property Office, the disclosure of which is incorporated herein in its entirety by reference.

### BACKGROUND OF THE INVENTION

1. Field of the Invention

Systems, methods and apparatuses consistent with the present invention relate to driving various types of optical media, and more particularly, to a method of quickly determining the type of an optical medium loaded into an optical medium driving system, the optical medium driving system, and a recording medium.

2. Description of the Related Art

An optical medium driving system writes data to or reads data from an optical medium loaded into the optical medium driving system. Most optical medium driving systems on the market are capable of writing data to or reading data from various types of optical media.

However, writing/reading characteristics depend on the type of optical medium. For instance, the writing/reading characteristics of a compact disc (CD) are different from those of a digital versatile disc (DVD). In the case of a CD, since a semiconductor laser diode has a wavelength of 780 mm and an objective lens has an aperture rate of 0.45, a laser spot formed on a recording surface of the CD is approximately 1.6 mm in diameter. In the case of a DVD, since a semiconductor laser diode has a wavelength of 635 or 650 mm and an objective lens has an aperture rate of 0.6, a laser spot formed on a recording surface of the DVD is approximately 1 mm in diameter. Also, the recording layer of the CD is formed to a depth of 1.2 mm, whereas that of the DVD is formed to a depth of 0.6 mm.

Accordingly, the optical medium driving system capable of writing data to or reading data from various types of optical media must determine the type of an optical medium loaded into the optical medium driving system before performing a write/read operation thereon. To determine the type of the loaded optical medium, the optical medium driving system must properly adjust at least the position of an optical pickup or the aperture rate of an objective lens according to the type of an optical medium to be determined and then determines the type of the loaded optical medium.

Conventionally, a sequence for determining the type of an optical medium loaded into the optical medium driving system is determined during the manufacture of the optical medium driving system. Therefore, although an initial booting time of the optical medium driving system changes according to the type of the loaded optical medium, an initial booting time for each type of optical media is fixed. Accordingly, when the type of an optical medium that a user has often used is set to be determined at the end of the process, the user would feel that it takes a lot of time to initially boot the optical medium driving system.

Also, it is impossible for the user to recognize the type of an optical medium being determined by the optical medium driving system. Therefore, when a write/read operation is not performed due to a failure of the determination of the type of the optical medium, it is difficult for the user to know that the write/read operation has not been performed due to the failure of the determination.

Further, in the case of a hybrid optical medium such as a super audio CD (SACD) having both a CD layer and a high density (HD) layer, the user may not be able to perform a read operation on a desired optical medium type. For instance, the user may desire to perform the read operation on an optical medium type corresponding to the HD layer, but the process has been set such that determining a type of an optical medium corresponding to the CD layer is performed prior to determining the optical medium corresponding to the HD layer. In this case, the optical medium driving system may determine the SACD as the optical medium type corresponding to the CD layer and thus perform the read operation on the optical medium type corresponding to the CD layer.

### SUMMARY OF THE INVENTION

The present invention provides a method of determining the type of an optical medium loaded into an optical medium driving system in a sequence. in which the types of optical media are listed according to the frequency of use, the optical medium driving system, and a recording medium therefor.

The present invention also provides a method of determining the type of an optical medium loaded into an optical medium driving system in a sequence in which the types of optical media are listed, the sequence being updated by a user, the optical medium driving system, and a recording medium therefor.

The present invention also provides a method of determining the type of an optical medium loaded into an optical medium driving system while indicating the type of an optical medium that is currently being determined, the optical medium driving system, and a recording medium therefor.

According to an aspect of the present invention, there is provided a method of determining the type of an optical medium loaded into an optical medium driving system, the method including determining the type of the loaded optical medium based on predetermined sequence information; and updating the predetermined sequence information based on the determined type of the loaded optical medium. The predetermined sequence information is updated such that the determined type of the optical medium outranks the other types of optical media listed in the predetermined sequence information.

The updating of the predetermined sequence information based on the determined type of the loaded optical medium includes comparing the determined type of the optical medium with the type of an optical medium with the highest priority which is listed in the predetermined sequence information; and updating the predetermined sequence information when the result of the comparing reveals that the determined type of the optical medium is not identical to the type of the optical medium with the highest priority.

The method further includes when the type of an optical medium to be determined is selected based on the predetermined sequence information, displaying the type of the selected optical medium.

The method further includes updating the predetermined sequence information based on input information.

According to another aspect of the present invention, there is provided an optical medium driving system comprising a loading unit which controls loading and uploading of an optical medium in the optical medium driving system; a pickup which outputs a signal pickup from the optical medium loaded into the optical medium driving system by the loading unit; a memory which stores sequence information for determining the type of an optical media; and a controller which adjusts the pickup to determine whether the type of the loaded optical medium is identical to the type of an optical medium selected based on the sequence information, and updates the sequence information such that the type of the loaded optical medium outranks the other types of the optical media listed in the sequence information.

According to another aspect of the present invention, there is provided a computer readable recording medium having embodied thereon a program for executing a method of determining the type of an optical medium loaded into an optical medium driving system, wherein the method includes determining the type of the loaded optical medium based on predetermined sequence information; and updating the predetermined sequence information according to the determined type of the optical medium. The predetermined sequence information is updated such that the type of the loaded optical medium outranks the other types of the optical media listed in the predetermined sequence information.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an optical medium driving system according to an exemplary embodiment of the present invention;

FIG. 2 is a diagram illustrating a method of updating information of a sequence for determining the types of optical media, according to an exemplary embodiment of the present invention;

FIG. 3 is a block diagram of an optical medium driving system according to another exemplary embodiment of the present invention;

FIG. 4 is a flowchart illustrating a method of determining the type of an optical medium loaded into an optical medium driving system according to an exemplary embodiment of the present invention;

FIG. 5 is a flowchart illustrating a method of updating information of a sequence for determining the types of optical media, the method being included in the method illustrated in FIG. 4, according to an exemplary embodiment of the present invention;

FIG. 6 is a flowchart illustrating a method of determining the type of an optical medium loaded into an optical medium driving system according to another exemplary embodiment of the present invention; and

FIG. 7 is a flowchart illustrating a method of allowing a user to update information of a sequence for determining the types of optical media, when determining the type of an optical medium loaded into an optical medium driving system, according to an exemplary embodiment of the present invention.

### DETAILED DESCRIPTION OF EXEMPLARY EMBODIMENTS

Hereinafter, exemplary embodiments of the present invention will be described in detail with reference the accompanying drawings.

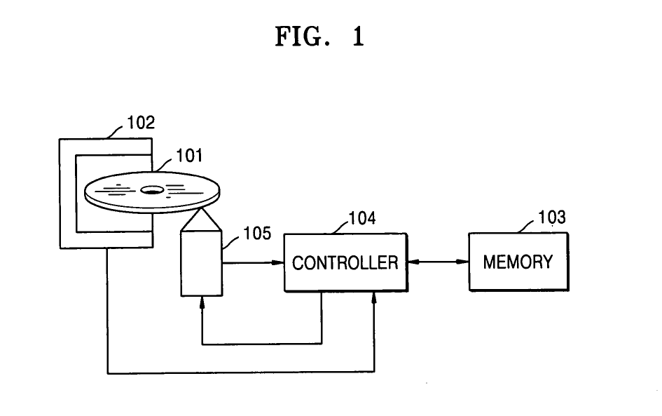

FIG. 1 is a block diagram of an optical medium driving system according to an exemplary embodiment of the present invention. The optical medium driving system includes an optical medium 101, a loading unit 102, a memory 103, a controller 104, and a pickup 105.

The optical medium 101 may be a compact disc recordable (CD-R), CD-rewritable (CD-RW), a CD-read only memory (CD-ROM), a DVD-read only memory (DVD-ROM), a DVD-recordable (DVD-R), a DVD-rewritable (DVD-RW), or a SACD. Also, the optical medium 101 may correspond to a first layer or a second layer of a single-faced optical medium, or a first layer or a second layer of a double-faced optical medium.

The loading unit 102 loads the optical medium 101 into or unloads the optical medium 101 from the optical medium driving system. The loading unit 102 may include a turntable (not shown) on which the optical medium 101 is to be placed, a roller arm (not shown) with a roller that guides loading or unloading of the optical medium 101, and a disc protecting unit (not shown) such as a cartridge.

The memory 103 stores information of a sequence (hereinafter referred to as “sequence information”) for determining the type of an optical medium. Updating of the stored sequence information may be controlled by the controller 104.

When it is determined that the loading unit 102 loads the optical medium 101 into the optical medium driving system or the optical medium driving system is requested to perform a write/read operation, the controller 104 reads the sequence information from the memory 103 and selects a type of an optical medium based on the read sequence information. The controller 104 sequentially selects various types of optical media as specified in the read sequence information.

The controller 104 also controls the pickup 105 to satisfy operating conditions for the selected type of the optical medium. The operating conditions may include the wavelength of a laser diode and the aperture rate of an objective lens.

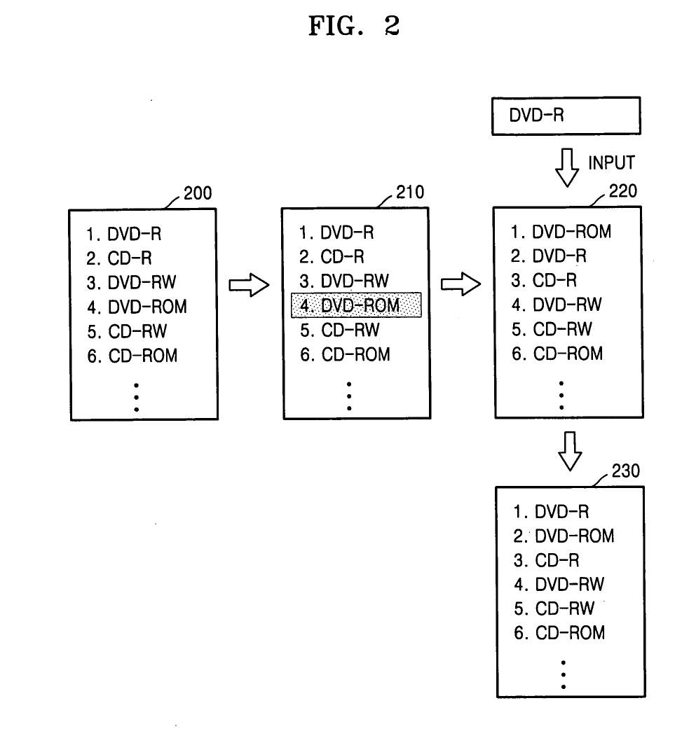

If the stored sequence information is defined as illustrated by, for example, block 200 in FIG. 2, the controller 104 first selects a DVD-R and adjusts the operating conditions of the pickup 105 to be suitable for the DVD-R. That is, the controller 104 considers the optical medium 101 as being a DVD-R, and adjusts the operating conditions of the pickup 105 to read data from or write data to the optical medium 101.

The pickup 105 reads data from or writes data to the optical medium 101. Also, the pickup 105 outputs a signal pickup from a recording surface of the optical medium 101 to determine the type of the optical medium 101.

A signal output from the pickup 105 when initially booting the optical medium driving system is input to the controller 104, and then the controller 104 determines the type of the optical medium 101 based on the received signal.

When the optical medium driving system is designed to determine the type of the optical medium 101 using a tracking error signal or a focusing error signal, the controller 104 determines the type of the optical medium 101 by detecting the tracking error signal or the focusing error signal from the signal output from the pickup 105 and by checking whether the detected tracking error signal or the detected focusing error signal satisfies a predetermined requirement.

When the optical medium driving system is designed to determine the type of the optical medium 101 using the reflection rate from the optical medium 101 when initially booting the optical medium driving system, the controller 104 determines the type of the optical medium 101 by determining the reflection rate from the signal output from the pickup 105 and by checking whether the determined reflection rate satisfies a predetermined requirement.

The predetermined requirement is determined according to a signal that the optical medium driving system uses in determining the type of the optical medium 101. For instance, when the type of the optical medium 101 is determined using the tracking error signal, the focusing error signal, or the reflection rate, the predetermined requirement may be the level of the tracking error signal, the focusing error signal, or the reflection rate, which corresponds to the selected type of the optical medium.

When the optical medium driving system is designed to determine the type of the optical medium 101 depending on whether a frame synchronization signal or a synchronization code signal is detected, the controller 104 determines the type of the optical medium 101 by determining whether the frame synchronization signal or the synchronization code signal is detected from the signal output from the pickup 105.

In addition, the controller 104 may determine the type of the optical medium 101 by using the signal output from the pickup 105 in various methods.

When the signal received from the pickup 105 satisfies the predetermined requirement, the controller 104 determines that the type of the optical medium 101 is identical to the selected type of the optical medium, e.g., the DVD-R specified in block 200 of FIG. 2. However, when the signal received from the pickup 105 does not satisfy the predetermined requirement, the controller 104 determines that the type of the optical medium 101 is not identical to the selected type of the optical medium, e.g., the DVD-R specified in block 200 of FIG. 2. Thus, the controller 104 selects a next type of an optical medium, e.g., a CD-R as illustrated in block 200 of FIG. 2, which is specified in the sequence information stored in the memory 103, and adjusts the operating conditions of the pickup 105 to be suitable for the selected type of the optical medium.

Then, the operating conditions of the pickup 105 are adjusted to be suitable for the selected type of optical medium, and the signal pickup from the optical medium 101 is transmitted to the controller 104. Next, the controller 104 determines the type of the optical medium 101 as described above. The above operation of the optical medium driving system is repeatedly performed until the type of the optical medium 101 is determined.

However, when the type of the optical medium 101 is determined to be identical to the selected type of the optical medium, the controller 104 compares the type of the optical medium 101 with that of an optical medium that is listed first in the sequence information stored in the memory 103. If the type of the optical medium 101 is identical to that of the first listed optical medium, the controller 104 completes determining the type of the optical medium 101 and controls a write operation or a read operation to be performed on the loaded optical medium 101.

However, when the type of the optical medium 101 is different from that of the first listed optical medium, the controller 104 updates the sequence information stored in the memory 103 such that the type of the optical medium 101 is first listed in the sequence information. In this case, the sequence in which the other types of the optical media, except the type of the optical medium 101, are listed in the sequence information stored in the memory 103, is maintained.

For instance, when the sequence information stored in the memory 103 is defined as illustrated in block 200 of FIG. 2 and the type of the loaded optical medium 101 is determined as a DVD-ROM marked in block 210 of FIG. 2, the controller 104 updates the sequence information stored in the memory 103 such that the type of the DVD-ROM is first listed while maintaining the sequence in which the other types of the optical media are listed.

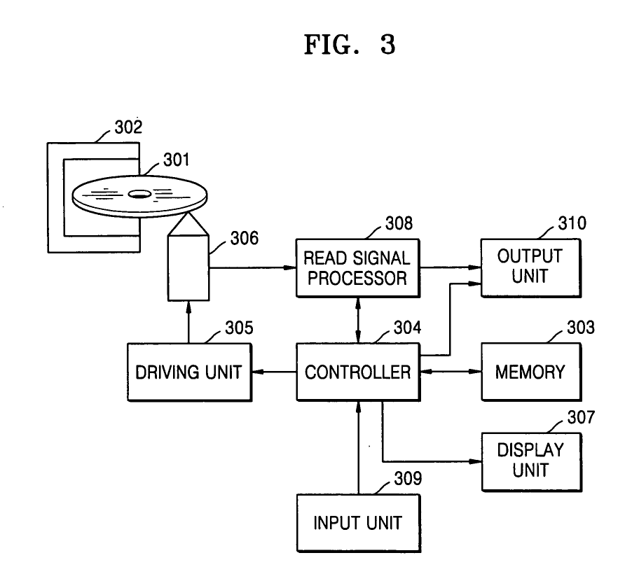

FIG. 3 is a block diagram of an optical medium driving system according to another exemplary embodiment of the present invention. Referring to FIG. 3, the optical medium driving system includes an optical medium 301, a loading unit 302, a memory 303, a controller 304, a driving unit 305, a pickup 306, a display unit 307, a read signal processor 308, an input unit 309, and an output unit 310.

The operations of the optical medium 301, the loading unit 302 and the memory 303 are the same as those of the optical medium 101, the loading unit 102 and the memory 103 illustrated in FIG. 1.

When the loading unit 302 recognizes that the optical medium 301 is loaded into the optical medium driving system or the optical medium driving system is requested to perform a write/read operation, the controller 304 reads sequence information from the memory 303 and selects a type of an optical medium based on the read sequence information. The controller 304 sequentially selects various types of optical media in a sequence defined in the read sequence information.

The controller 304 controls the pickup 306 to satisfy operating conditions for the selected type of optical medium. The operating conditions may include the wavelength of a laser diode and the aperture rate of an objective lens.

If the sequence information stored in the memory 303 is defined as illustrated in block 200 of FIG. 2, the controller 304 first selects a DVD-R and adjusts the operating conditions of the pickup 306 to be suitable for the DVD-R. That is, the controller 304 regards the optical medium 301 as the DVD-R, and adjusts the operating conditions of the pickup 306 using the driving unit 305 so as to read data from or write data to the optical medium 301.

Also, when the type of an optical medium to be determined is selected according to the sequence specified in the sequence information, the controller 304 controls the display unit 307 to display the selected optical medium. For instance, when the selected optical medium is a DVD-R, the DVD-R is displayed on the display unit 307 so that a user can notice whether the type of the loaded optical medium 301 is the DVD-R.

Accordingly, it is assumed that when the selected optical medium of block 200 is a DVD-R and the user knows this fact, the DVD-R is displayed on the display unit 307 but a next type of an optical medium to be determined, e.g., a CD-R, is selected and displayed on the display unit 307 since the controller 304 determines that the optical medium 301 is not a DVD-R. In this case, the user can notice if an error occurs when the optical medium driving system determines the type of the loaded optical medium 301.

The driving unit 305 drives the pickup 306 to move upward, downward, or in a tracking direction under control of the controller 304.

The pickup 306 reads data from or writes data to the optical medium 301, and outputs a signal pickup from a recording surface of the optical medium 301 to determine the type of the optical medium 301.

The signal output from the pickup 306 is input to the read signal processor 308. In a normal read mode, the read signal processor 308 receives the signal from the pickup 306, transforms the format of the read signal in a reproducible format, and outputs the transformed signal.

When the optical medium driving system is initially booted, the read signal processor 308 generates an optical medium type determination signal in response to the signal received from the pickup 306. When the optical medium driving system is designed to determine the type of the optical medium 301 using a tracking error signal or a focusing error signal, the generated optical medium type determination signal may be the tracking error signal or the focusing error signal. When the optical medium driving system is designed to determine the type of the optical medium 301 depending on whether a frame synchronization signal or a synchronization code signal is detected, the generated optical medium type determination signal may be a signal indicating whether the frame synchronization signal or the synchronization code signal is detected.

When the optical medium driving system is designed to determine the type of the optical medium 301 using the reflection rate from the optical medium 301, the read signal processor 308 may generate the optical medium type determination signal using a signal detected using the reflection rate during the initial booting of the optical medium driving system. The read signal processor 308 transmits the generated optical medium type determination signal to the controller 304.

When receiving the optical medium type determination signal from the read signal processor 308, the controller 304 determines whether the type of the optical medium 301 is identical to that of the selected optical medium, using the received optical medium type determination signal and a predetermined requirement. The predetermined requirement is determined according to a signal used by the optical medium driving system in determining the type of the optical medium 301.

If the tracking error signal, the focusing error signal, or the reflection rate is used in determining the type of the optical medium 301, the predetermined requirement may be the level of the tracking error signal, the focusing error signal, or the reflection rate, which corresponds to the type of the selected optical medium. If the frame synchronization signal or the synchronization code signal is used, the predetermined requirement may be information indicating whether the frame synchronization signal or the synchronization code signal must be detected in the case of the type of the selected optical medium.

Thus, when the signal received from the read signal processor 308 satisfies the predetermined requirement, the controller 304 determines that the type of the optical medium 301 is identical to that of the selected optical medium (DVD-R illustrated in block 200 of FIG. 2).

However, when the signal received from the read signal processor 308 does not satisfy the predetermined requirement, the controller 304 determines that the type of the optical medium 301 is not identical to that of the selected optical medium (DVD-R illustrated in block 200 of FIG. 2). Thus, the controller 304 selects a next optical medium (CD-R illustrated in block 200 of FIG. 2) described in the sequence information stored in the memory 303 and controls the pickup 306 to satisfy operating conditions for the type of the selected optical medium.

Then, the operating conditions of the pickup 306 are adjusted to be suitable for the selected optical medium, e.g., the CD-R, and the signal pickup from the optical medium 301 is transmitted to the read signal processor 308. The read signal processor 308 generates the optical medium type determination signal from the received signal as described above, and transmits it to the controller 304. Next, the controller 304 determines the type of the optical medium 301 using the optical medium type determination signal as described above.

The above operation of the optical medium driving system is repeatedly performed until the type of the optical medium 301 is determined.

When determining the type of the optical medium 301 to be identical with that of the selected optical medium, the controller 304 compares the type of the optical medium 301 with that of an optical medium with the highest priority specified in the sequence information stored in the memory 303. If the comparison reveals that the type of the optical medium 301 is identical to that of the optical medium with the highest priority, the controller 304 completes the determining of the type of the loaded optical medium 301 and starts a write/read operation to be performed on the loaded optical medium 301.

If the comparison reveals that the type of the optical medium 301 is different from that of the optical medium with the highest priority, the controller 304 updates the sequence information stored in the memory 303 such that the type of the loaded optical medium 301 from among the other types of the optical media is first determined. In this case, the sequence in which the other types of the optical media, except the type of the loaded optical medium 301, are listed in the sequence information stored in the memory 303, is maintained.

For instance, when the sequence in which the types of optical media are listed in the sequence information stored in the memory 303, is as illustrated in block 200 of FIG. 2 and the type of the loaded optical medium is considered a DVD-ROM as marked in a block 210 of FIG. 2, the sequence information is updated such that the type of the DVD-ROM outranks the other types of the optical media as illustrated in block 220 of FIG. 2 while maintaining the sequence for determining the other types of the optical media.

When receiving a user input that instructs the sequence information to be updated via the input unit 309, the controller 304 reads the sequence information from the memory 303, makes a list of optical media that are arranged in the sequence in which the types of the optical media are determined based on the read sequence information, and provides it to the read signal processor 308. The read signal processor 308 formats the received list such that the listed optical media are displayed as illustrated in the block 220 of FIG. 2, and transmits the formatted list to the output unit 310.

In particular, the controller 304 provides information received from the input unit 309 to the read signal processor 308 so that a screen displaying information reflecting a change requested by the user is output as illustrated in a block 230 of FIG. 2, thereby allowing the user to recognize the information received from the input unit 309. The read signal processor 308 receives the information output from the input unit 309 and transmits it to the output unit 310 so as to output the changed list.

The controller 304 can also output the list directly to the output unit 310.

The output unit 310 can output the list as a text screen as illustrated in FIG. 2. In other words, when the user requests the sequence information to be updated via the input unit 309, the controller 304 controls the output unit 310 to output the list as illustrated in block 220 of FIG. 2. When the user requests a DVD-R to be set as an optical medium with highest priority via the input unit 309, the controller 304 controls the output unit 310 to output a list in which the sequence for determining the types of optical media changed, as illustrated in block 230 of FIG. 2.

When receiving a user command instructing that the list output to the output unit 310 is acceptable via the input unit 309, the controller 304 updates the sequence information stored in the memory 303 based on the output list. The output unit 310 may be a display unit such as a television, a personal computer, and a monitor.

The user inputs information to the controller 304 via the input unit 309. In particular, when the sequence information is to be updated according to an exemplary embodiment of the present invention, a signal requesting updating of the sequence information and the sequence information may be input via the input unit 309. For instance, when the user desires to perform a read operation on a HD layer of a hybrid optical medium such as a SACD via the input unit 309, the user can input information indicating that the sequence information must be changed such that the optical medium corresponding to the HD layer is selected prior to an optical medium corresponding to a CD layer based on the list.

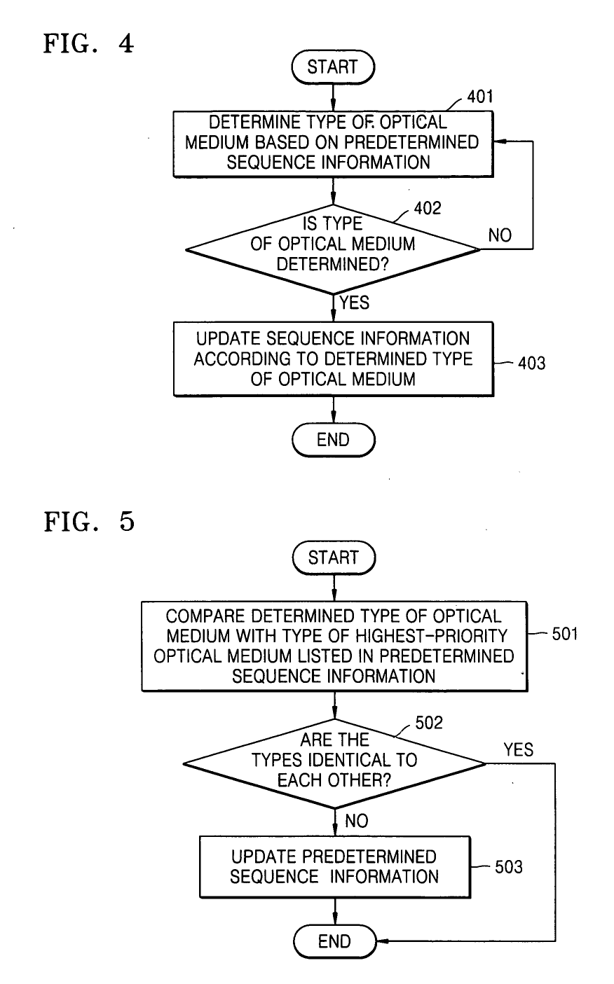

FIG. 4 is a flowchart illustrating a method of determining the type of an optical medium according to an exemplary embodiment of the present invention. The method of FIG. 4 will now be described with reference to FIG. 1.

First, when an optical medium driving system is controlled to perform a read/write operation or the loading unit 102 loads the optical medium 101 into the optical medium driving system, the controller 104 determines the type of the optical medium 101 based on predetermined sequence information stored in the memory 103 (operation 401). In this case, the controller 104 may determine the type of the loaded optical medium 101 as described above with reference to FIG. 1.

Operation 401 is repeatedly performed until the type of the optical medium 101 is determined. When the type of the optical medium 101 is determined in operation 402, the controller 104 updates the sequence information such that the determined type of the optical medium 101 outranks the other types of the optical media (operation 403).

The sequence information may be updated as illustrated in FIG. 5. FIG. 5 is a flowchart illustrating a method of updating the sequence information, performed in the method illustrated in FIG. 4, according to an exemplary embodiment of the present invention.

Referring to FIG. 5, the type of the optical medium with the highest priority, which is listed in the sequence information stored in the memory 103, is compared with that of the loaded optical medium 101 (operation 501).

If it is determined in operation 501 that the type of the optical medium with highest priority is identical with that of the loaded optical medium 101, the controller 104 does not update the sequence information stored in the memory 103 (operation 502). However, if it is determined in operation 501 that the type of the optical medium with highest priority is different from that of the loaded optical medium 101, the controller 104 updates the sequence information such that the type of the loaded optical medium 101 outranks the other types of the optical media (operation 503).

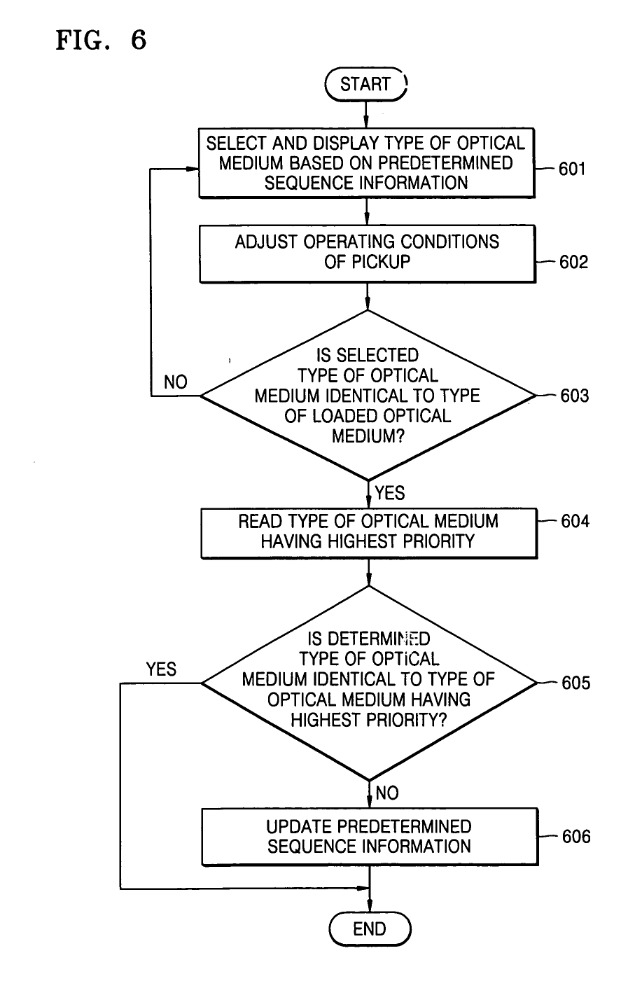

FIG. 6 is a flowchart illustrating a method of determining the type of an optical medium according to another exemplary embodiment of the present invention. The method of FIG. 6 will now be described with reference to FIG. 3.

When an optical medium driving system is controlled to perform a read/write operation or the loading unit 302 loads the optical medium 301 into the optical medium driving system, the controller 304 selects a type of an optical medium to be determined based on predetermined sequence information stored in the memory 303 and displays the selected type of the optical medium on the display unit 307 (operation 601).

Next, the controller 304 adjusts the operating conditions of the pickup 306 to be suitable for the selected type of the optical medium (operation 602). Next, the controller 304 determines whether the type of the loaded optical medium 301 is identical to the selected type of the optical medium by comparing a signal output from the pickup 306 having the adjusted operating conditions with a predetermined requirement (operation 603). The predetermined requirement has been described above with respect to the controller 304 of FIG. 3.

When it is determined in operation 603 that the type of the loaded optical medium 301 is different from the selected type of the optical medium, the method returns to operation 601, and the controller 304 selects and displays a next type of an optical medium based on the sequence information, and repeatedly performs operations 602 and 603.

However, when it is determined in operation 603 that the type of the loaded optical medium 301 is identical to the selected type of the optical medium, the controller 304 detects the type of an optical medium with the highest priority from the sequence information stored in the memory 303 (operation 604).

Next, the controller 304 determines whether the detected type of the optical medium with the highest priority is identical with the determined type of the optical medium (operation 605). If it is determined in operation 605 that the detected type of the optical medium is identical to the determined type of the optical medium, the controller 304 completes the determining of the type of the loaded optical medium 301 without updating the sequence information stored in the memory 303.

However, if it is determined in operation 605 that the detected type of the optical medium is not identical to the determined type of the optical medium, the controller 304 updates the sequence information stored in the memory 303 such that the determined type of the optical medium outranks the other types of the optical media in the sequence information (operation 606), and then completes determining the type of the loaded optical medium 301.

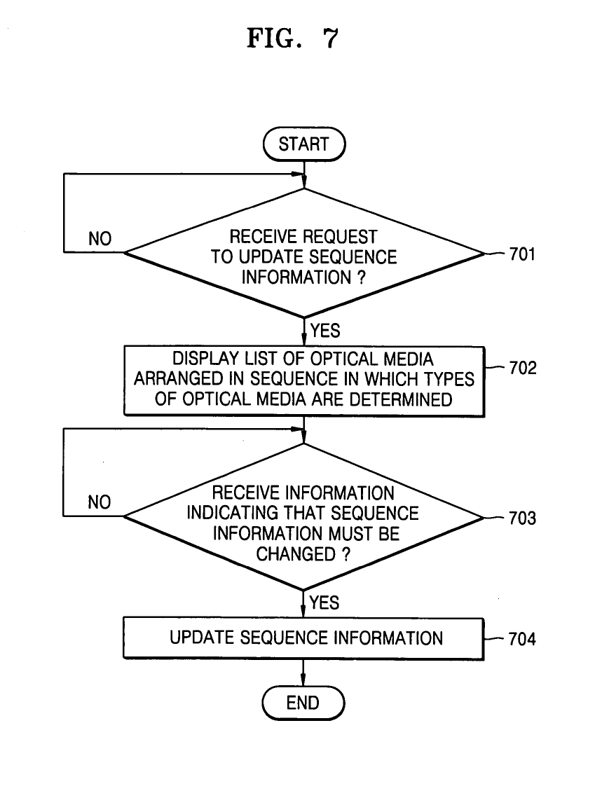

The sequence information stored in the memory 303 may be updated by the user. FIG. 7 is a flowchart illustrating a method of allowing a user to update the sequence information according to an exemplary embodiment of the present invention. Referring to FIG. 7, when receiving the user's request to update the sequence information via the input unit 309 (operation 701), the controller 304 reads the sequence information from the memory 303, and makes a list of optical media arranged in a sequence for determining the types of the optical media. Next, the controller 304 provides the list to the read signal processor 308 or the output unit 310 so that the list such as that illustrated in FIG. 2 is displayed on the output unit 310 (operation 702).

When receiving information indicating that the sequence information must be changed via the input unit 309 (operation 703), the controller 304 updates the sequence information based on the received information (operation 704). In this case, the controller 304 displays the sequence information changed according to the received information on the output unit 310 so that the user can notice a change in the original sequence information.

The present invention may be embodied as a computer program. Codes and code segments of the computer program could have easily been derived by computer programmers in the art. The computer program may be stored in a computer readable medium. When the computer program is read and executed using a computer, a method of generating a parity check matrix is accomplished. The computer readable medium may be any medium, such as a magnetic recording medium, an optical recording medium, and a carrier wave medium.

As described above, according to an exemplary embodiment of the present invention, it is possible to quickly determine the type of an optical medium loaded into an optical medium driving system based on sequence information made according to the frequency of using a medium, thereby reducing a time required to start a read/write operation to be performed normally after the optical medium is loaded into the optical medium driving system.

According to an exemplary embodiment of the present invention, it is possible to reduce the time required to initially boot the optical medium driving system by determining the type of the loaded optical medium based on the sequence information updated by a user. In the case of a hybrid disc, it is possible to perform a read/write operation on a desired optical medium.

Also, according to an exemplary embodiment the present invention, it is possible to allow the user to notice the type of the optical medium by displaying the type of an optical medium being determined outside the optical medium driving system. If the user is aware of the type of an optical medium loaded into the optical medium driving system, the user can easily determine whether the optical medium driving system erroneously determines or cannot determine the type of the loaded optical medium.

For instance, it is assumed that the optical medium loaded into the optical medium driving system is a DVD, but the optical medium driving system determines that the loaded optical medium is not a DVD in a process of determining whether the loaded optical medium is a DVD or determines that the loaded optical medium is a CD in a process of determining whether the loaded optical medium is a CD. In this case, according to an exemplary embodiment of the present invention, the user can notice an error occurring in the optical medium driving system and correct the error.

When correcting the error, if the type of the loaded optical medium does not have priority over the other types of optical media listed in the displayed sequence information, it is possible to set the type of the loaded optical medium to be an optical medium with the highest priority.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of determining a type of an optical medium loaded into an optical medium driving system, the method comprising:
determining the type of the loaded optical medium based on predetermined sequence information; and
updating the predetermined sequence information based on the determined type of the loaded optical medium, wherein, the predetermined sequence information is updated such that the determined type of the optical medium outranks the other types of optical media listed in the predetermined sequence information.

2. The method of claim 1, wherein the updating of the predetermined sequence information based on the determined type of the loaded optical medium comprises:
comparing the determined type of the optical medium with a type of an optical medium with a highest priority which is listed in the predetermined sequence information; and
updating the predetermined sequence information if the result of the comparing reveals that the determined type of the optical medium is not identical to the type of the optical medium with the highest priority.

3. The method of claim 2, wherein during updating of the predetermined sequence information based on the determined type of the loaded optical medium, a sequence of the other types of the optical media listed in the predetermined sequence information, except the type of the loaded optical medium, is maintained.

4. The method of claim 3, further comprising if the type of the optical medium to be determined is selected based on the predetermined sequence information, displaying the type of the selected optical medium.

5. The method of claim 1, wherein during updating of the predetermined sequence information based on the determined type of the loaded optical medium, a sequence of the other types of the optical media listed in the predetermined sequence information, except the type of the loaded optical medium, is maintained.

6. The method of claim 2, further comprising if the type of the optical medium to be determined is selected based on the predetermined sequence information, displaying the selected type of the optical medium.

7. The method of claim 5, further comprising updating the predetermined sequence information based on input information.

8. The method of claim 1, further comprising if a type of the optical medium to be determined is selected based on the predetermined sequence information, displaying the selected type of the optical medium.

9. The method of claim 1, further comprising updating the predetermined sequence information based on input information.

10. The method of claim 9, wherein the updating of the predetermined sequence information based on the input information comprises:
if a user inputs a signal requesting the predetermined sequence information to be updated, displaying a list of the optical media arranged in the sequence for determining the type of the optical medium, based on the predetermined sequence information; and
if the user inputs information indicating that the sequence must be changed based on the displayed list, updating the predetermined sequence information based on the input information.

11. An optical medium driving system comprising:
a loading unit which controls loading and uploading of an optical medium in the optical medium driving system;
a pickup which outputs a signal pickup from the optical medium loaded into the optical medium driving system by the loading unit;
a memory which stores sequence information for determining a type of an optical medium; and
a controller which adjusts the pickup to determine whether the type of the loaded optical medium is identical to the type of an optical medium selected based on the sequence information, and updates the sequence information such that the type of the loaded optical medium outranks the other types of the optical media listed in the sequence information.

12. The optical medium driving system of claim 11, further comprising a display unit, which displays the selected type of the optical medium under control of the controller.

13. The optical medium driving system of claim 12, further comprising an input unit through which instructions for instructing the sequence information to be updated are input.

14. The optical medium driving system of claim 11, further comprising an input unit through instructions for instructing the sequence information to be updated are input.

15. The optical medium driving system according to claim 11, wherein the controller compares the determined type of the optical medium with a type of an optical medium with a highest priority which is listed in the sequence information stored in the memory; and updates the sequence information if the result of the comparing reveals that the determined type of the optical medium is not identical to the type of the optical medium with the highest priority stored in the memory.

16. The optical medium driving system according to claim 11, wherein during the updating of the sequence information based on the determined type of the loaded optical medium, a sequence of the other types of the optical media listed in the sequence information, except the type of the loaded optical medium, is maintained.

17. The optical medium driving system according to claim 13, wherein if a user inputs a signal requesting the sequence information to be updated, the display unit displays a list of the optical media arranged in the sequence for determining the type of the optical medium, based on the sequence information stored in the memory; and
if the user inputs information indicating that the sequence must be changed based on the displayed list, the controller updates the sequence information stored in the memory based on the input information.

18. A computer readable recording medium having embodied thereon a program for executing a method of determining the type of an optical medium loaded into an optical medium driving system, wherein the method comprises:
determining the type of the loaded optical medium based on predetermined sequence information; and
updating the predetermined sequence information according to the determined type of the optical medium, wherein, the predetermined sequence information is updated such that the type of the loaded optical medium outranks the other types of the optical media listed in the predetermined sequence information.
